(19) United States
(12) Patent Application Publication
(10) Pub. No.: US 2016/0139562 A1
(43) Pub. Date: May 19, 2016

(54) ENHANCED PEPPER'S GHOST ILLUSION USING VIDEO PANEL DISPLAYS

(71) Applicant: VENTANA 3D, LLC, Santa Monica, CA (US)

(72) Inventors: Ashley Crowder, Venice, CA (US); Benjamin Conway, Santa Monica, CA (US); Troy P. Senkiewicz, Toluca Lake, CA (US)

(21) Appl. No.: 14/939,757

(22) Filed: Nov. 12, 2015

Related U.S. Application Data
(60) Provisional application No. 62/078,503, filed on Nov. 12, 2014.
(60) Provisional application No. 62/132,131, filed on Mar. 12, 2015.

(51) Int. Cl. G03H 1/22; A63J 21/00; G02B 27/14

(52) U.S. Cl. CPC G03H 1/2205; G02B 27/144; A63J 21/00; G03H 2001/2215

(57) ABSTRACT

Systems and methods herein are directed to creating a holographic image (e.g., in line with Pepper's Ghost Illusion) with a panel display (e.g., Plasma, liquid crystal display (LCD), light-emitting diode (LED), etc.) as the light source for the holographic image. As described herein, such displays may include any size display, such as ranging from personal electronic equipment (e.g., watches, mobile phones, tablets, laptops, monitors, televisions, etc.) through to stage-sized displays for larger venues (e.g., concerts, stage shows, etc.). In addition, a diffusion layer may be provided in order to reduce or generally eliminate a “Moiré effect” that occurs due to physical properties of the interaction between the panel display and transparent screen.

### RELATED APPLICATIONS

The present application claims priority to U.S. Provisional Patent Application Ser. No. 62/078,503, entitled “HOLOGRAPHIC PROJECTION SYSTEM AND ENHANCED PEPPER'S GHOST ILLUSION”, filed on Nov. 12, 2014 by Crowder et al., the entire contents of which being incorporated by reference in its entirety.

The present application also claims priority to U.S. Provisional Patent Application Ser. No. 62/132,131, entitled “ENHANCED PEPPER'S GHOST ILLUSION USING VIDEO PANEL DISPLAYS”, filed on Mar. 12, 2015 by Crowder et al., the entire contents of which being incorporated by reference in its entirety.

### TECHNICAL FIELD

The present disclosure relates generally to holographic projection, and, more particularly, to an enhanced Pepper's Ghost Illusion using video panel displays.

### BACKGROUND

The “Pepper's Ghost Illusion” is an illusion technique known for centuries (named after John Henry Pepper, who popularized the effect), and has historically been used in theatre, haunted houses, dark rides, and magic tricks. It uses plate glass, Plexiglas, or plastic film and special lighting techniques to make objects seem to appear or disappear, become transparent, or to make one object morph into another. Traditionally, for the illusion to work, the viewer must be able to see into a main room, but not into a hidden room. The hidden room may be painted black with only light-colored objects in it. When light is cast on the room, only the light objects reflect the light and appear as ghostly translucent images superimposed in the visible room.

Notably, Pepper's Ghost Illusion systems have generally remained the same since the 19th Century, adding little more over time than the use of projection systems that either direct or reflect light beams onto the transparent angled screen, rather than using live actors in a hidden room. That is, technologies have emerged in the field of holographic projection that essentially mimic the Pepper's Ghost Illusion, using projectors as the light source to send a picture of an object or person with an all-black background onto a flat, high-gain reflection surface (also referred to as a “bounce”), such as white or grey projection screen. The bounce is typically maintained at an approximate 45-degree angle to the transparent screen surface.

For example, a recent trend in live music performances has been to use a holographic projection of a performer (e.g., live-streamed, pre-recorded, or re-constructed). FIG. 1 illustrates an example of a conventional (generally large-scale) holographic projection system 100. Particularly, the streamed (or recorded, or generated) image of the artist (or other object) may be projected onto a reflective surface, such that it appears on an angled screen and the audience sees the artist or object and not the screen. If the screen is transparent, this allows for other objects, such as other live artists, to stand in the background of the screen, and to appear to be standing next to the holographic projection when viewed from the audience.

Still, despite its historic roots, holographic projection technology is an emerging field, particularly with regards to various aspects of enhancing the illusion and/or managing the setup of the system.

For instance, holographic projections techniques today generally use projection systems that either direct or reflect light beams onto the transparent angled screen. That is, current systems use projectors as the light source, which sends a picture of an object or person with an all-black background onto a high gain reflection surface (also referred to as a “bounce”) such as white or grey projection screen. The bounce is at an approximate 45-degree angle to the transparent flat surface. Notably, however, there are issues with using projectors in this manner. For example, if atmosphere (e.g., smoke from a fog machine) is released, the viewer can see where the light is coming from, thus ruining the effect. Also, projectors are not typically bright enough to shine through atmosphere, which causes the reflected image to look dull and ghost-like. Moreover, projectors are large and heavy which leads to increased space requirements and difficulty rigging.

### SUMMARY

According to one or more embodiments herein, systems and methods are directed to creating a holographic image (e.g., in line with Pepper's Ghost Illusion) with a video panel display (e.g., Plasma, liquid crystal display (LCD), light-emitting diode (LED), etc.) as the light source for the holographic image. As described herein, such displays may include any size display, such as ranging from personal electronic equipment (e.g., watches, mobile phones, tablets, laptops, monitors, televisions, etc.) through to stage-sized displays for larger venues (e.g., concerts, stage shows, etc.). In addition, a diffusion layer may be provided in order to reduce or generally eliminate a “Moiré effect” that occurs due to physical properties of the interaction between the panel display and transparent screen.

Other specific embodiments, extensions, or implementation details are also described below.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example of well-known holographic projection techniques;

FIG. 2 illustrates an example of a holographic projection system using video panel displays, with the panel below a transparent screen;

FIG. 3 illustrates an example of a holographic projection system using video panel displays, with the panel above a transparent screen;

FIGS. 4-5 illustrate an example of a holographic projection system in a large (e.g., stage) format;

FIGS. 6-7 illustrate an example of a holographic projection system in a small or “mini” (e.g., personal) format;

FIG. 8 illustrates another example holographic projection system using panel displays on its side in accordance with one or more embodiments described herein; and

FIG. 9 illustrates an example simplified procedure for using video panel displays for an enhanced Pepper's Ghost Illusion in accordance with one or more embodiments described herein.

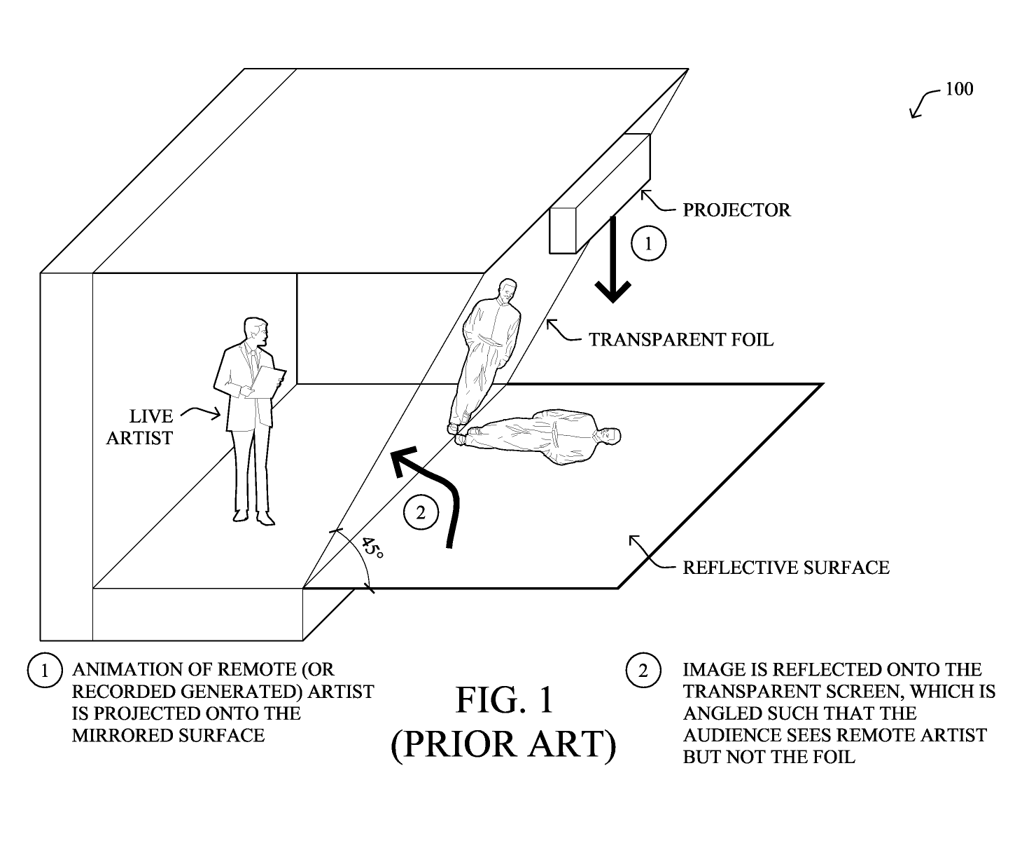

### DESCRIPTION OF EXAMPLE EMBODIMENTS

An example holographic projection system according to one or more embodiments described herein generally comprises hardware that enables holographic projections based on the well-known Pepper's Ghost Illusion, but in certain key arrangements and with certain key elements. In particular, the system, as described below, uses a smooth, transparent (e.g., glass-like) surface and lighting techniques to make objects seem to appear or disappear, become transparent, or to make one object morph into another, where, as mentioned above, the illusion is commonly used for (but not limited to) entertainment purposes to project performers that are not physically present and add surreal special effect elements that would not otherwise be possible in a performance or display.

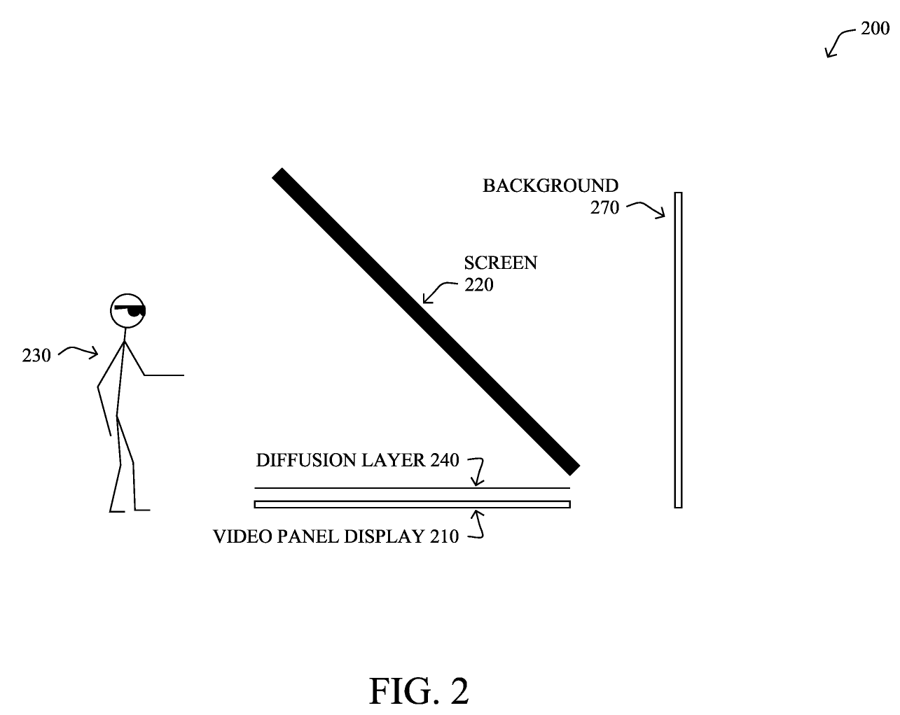

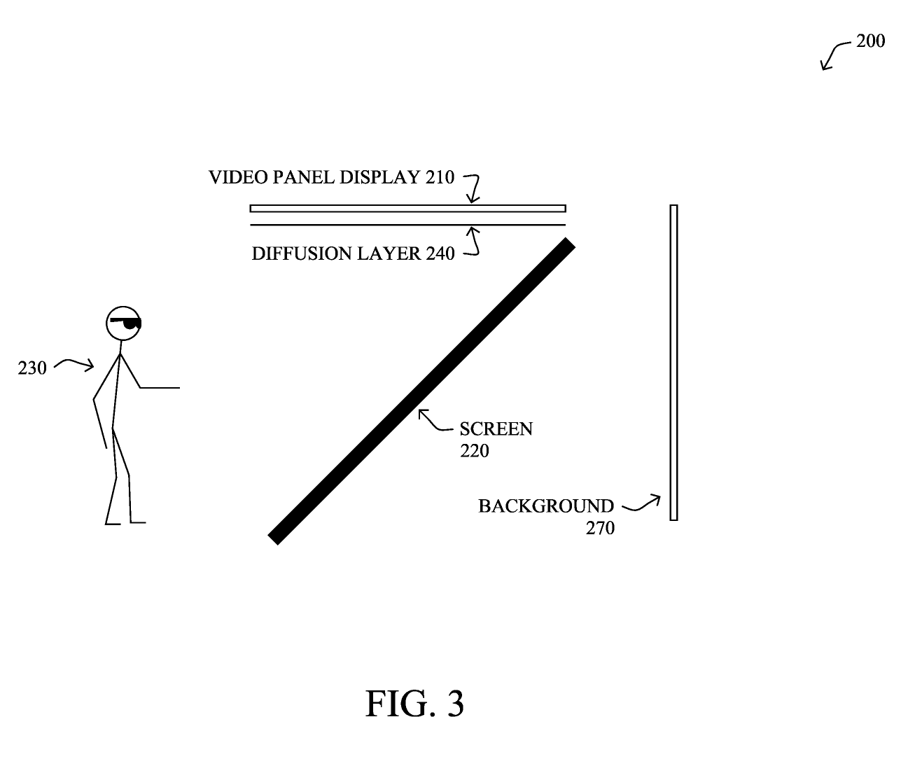

According to one or more embodiments of the invention herein, and with reference generally to FIGS. 2 and 3, the hologram projection system 200 may be established with video panel displays 210, such as LED or LCD panels, mobile phones, tablets, laptops, or monitors as the light source, rather than a projection-based system. In particular, the system herein allows for holographic projection for any size setup, such as from personal “mini” displays (e.g., phones, tablets, etc.) up to the larger full-stage-size displays (e.g., with custom-sized LCD or LED panels). Generally, a preferred angle between the image light source (panel display 210) and the screen 220, a reflective yet transparent surface (clear screen), is an approximate 45-degree angle, whether the display 210 is placed below the transparent screen (FIG. 2) or above it (FIG. 3).

The stick figure illustrates the viewer 230, that is, from which side one can see the holographic projection. Note that the system typically provides about 165-degrees of viewing angle. (Also note that various dressings and props can be designed to hide various hardware components and/or to build an overall scene, but such items are omitted for clarity.)

The transparent screen 220 is generally a flat surface that has similar light properties of clear glass (e.g., glass, plastic such as Plexiglas or tensioned plastic film). For example, a tensioning frame may be used to stretch a clear foil into a stable, wrinkle-free (e.g., and vibration resistant) reflectively transparent surface (that is, displaying/reflecting light images for the holographic projection, but allowing the viewer to see through to the background). Generally, for larger displays it may be easier to use a tensioned plastic film as the reflection surface because glass or rigid plastic (e.g., Plexiglas) is difficult to transport and rig safely.

The light source (panel display 210) itself can be any suitable video display panel, such as a plasma screen, an LED wall, an LCD screen, a monitor, a TV, a mobile phone, etc., and may be a rigid or flexible display. A variety of sizes can be used. When an image (e.g., stationary or moving) is shown on the video display panel, such as a person or object within an otherwise black (or other stable dark color) background, that image is then reflected onto the transparent screen 220 (e.g., tensioned foil or otherwise), appearing to the viewer 230 (shown as the stick figure) in a manner according to Pepper's Ghost Illusion. However, different from the original Pepper's Ghost Illusions using live actors/objects, and different from projector-based holographic systems, the use of video panel displays reduces or eliminates the “light beam” effect through atmosphere (e.g., fog), allowing for a clearer and un-tainted visual effect of the holographic projection. Also, using a video panel display may help hide projector apparatus, and may reduce the overall size of the holographic system.

Additionally, some video panels such as LED walls are able to generate a much brighter image than projectors are able to generate thus allowing the Pepper's Ghost Illusion to remain effective even in bright lighting conditions (which generally degrade the image quality). The brighter image generated from an LED wall also allows for objects behind the foil to be more well-lit than they can be when using projection.

Using a video panel display may, however, be associated with other unwanted effects. For instance, the Moiré effect is a visual perception that occurs when viewing a set of lines or dots that is superimposed on another set of lines or dots, where the sets differ in relative size, angle, or spacing. (For example, the Moiré effect can be seen when looking through ordinary window screens at another screen or background, or when trying to take a digital picture of another digital display, such viewing a phone screen as it takes a picture of a laptop screen.) The phenomenon generally degrades the quality and resolution of graphic images.

According to techniques herein, therefore, a diffusion layer may be used to reduce or otherwise eliminate this effect. That is, as illustrated in FIGS. 2-3, a diffusion layer 240 (e.g., a panel or material) may be placed between the light source (panel display 210) and the transparent screen 220 to eliminate the Moiré effect on the reflection surface. Example materials that get rid of this effect may be comprised of a transparent material that diffuses light such as rear projection screen, grid cloth, frosted glass, silk, and other known industry-standard light diffusion materials. In general, while it is preferred that the diffusion layer be placed generally out-of-sight (e.g., with the video display panel), other orientations are possible under different circumstances (e.g., against or as part of the transparent screen).

Notably, “pitch distance” of the visual display panel affects the amount of diffusion required. For instance, when specifically using LED panels, the LED panels with a larger pitch have lights that are further apart, possibly causing pixilation in the reflected image. However, the price of LED panels increases as the pitch is decreased due to the number of lights per panel. In order to use LED panels with a larger pitch (and at a reduced cost), therefore, more diffusion is required to ensure a crisp reflected image.

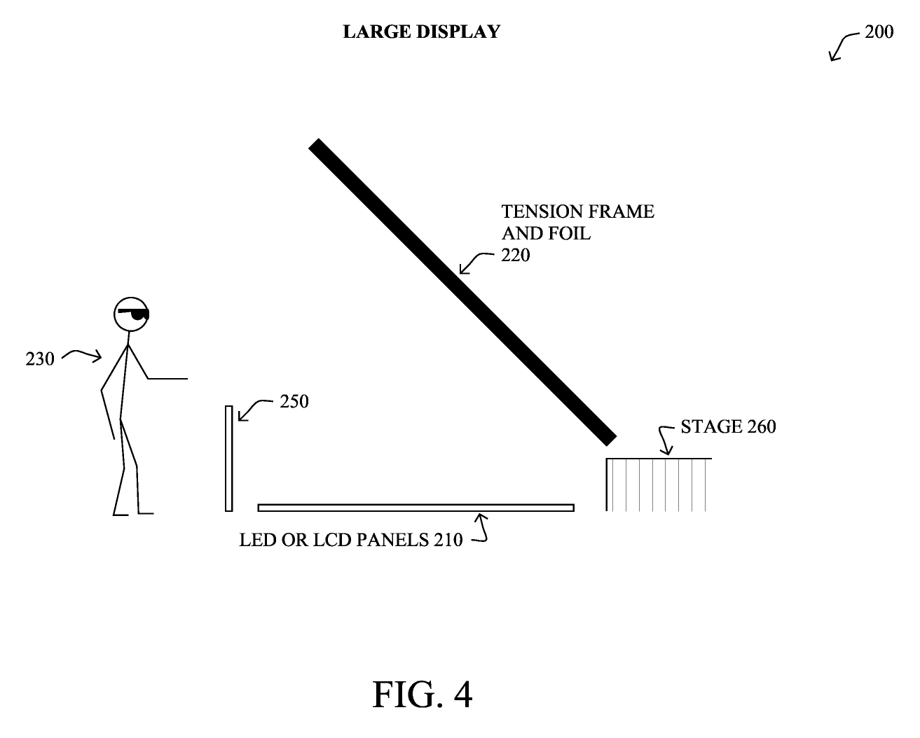

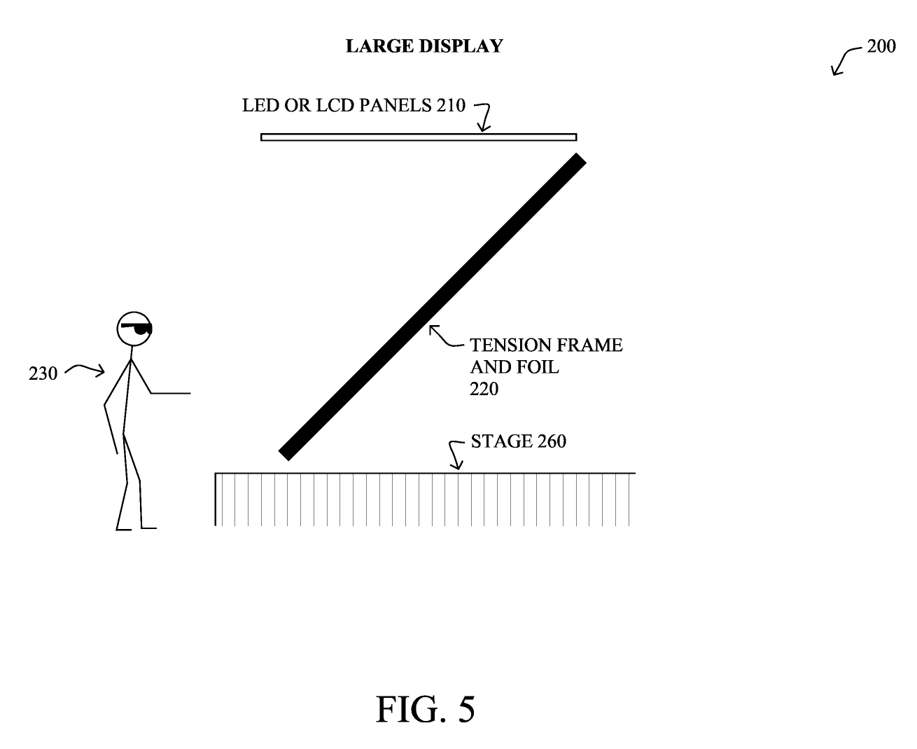

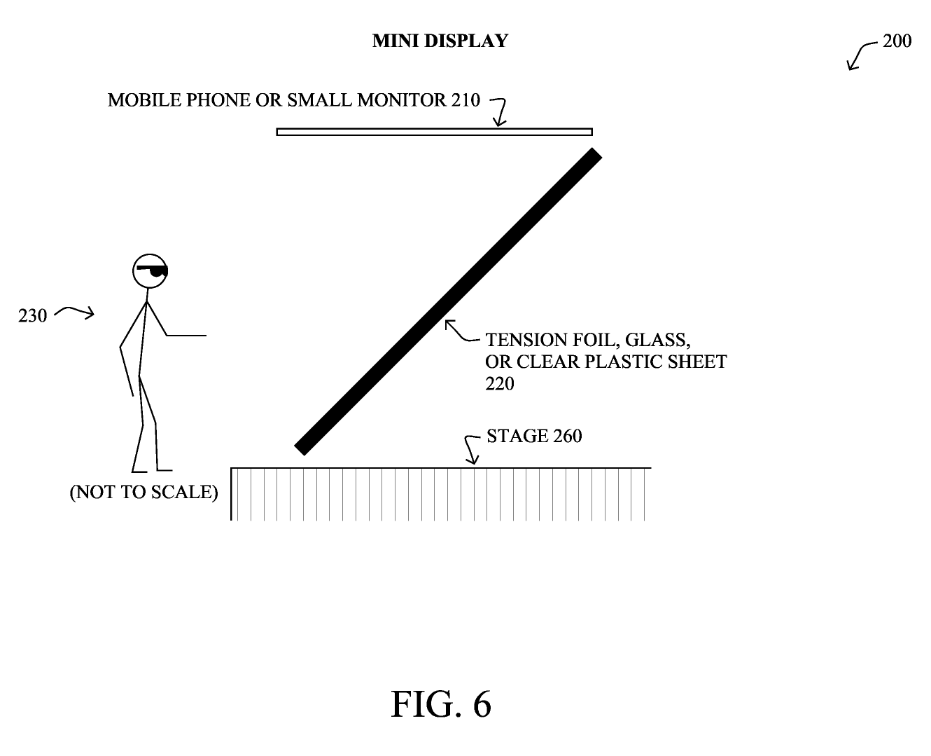

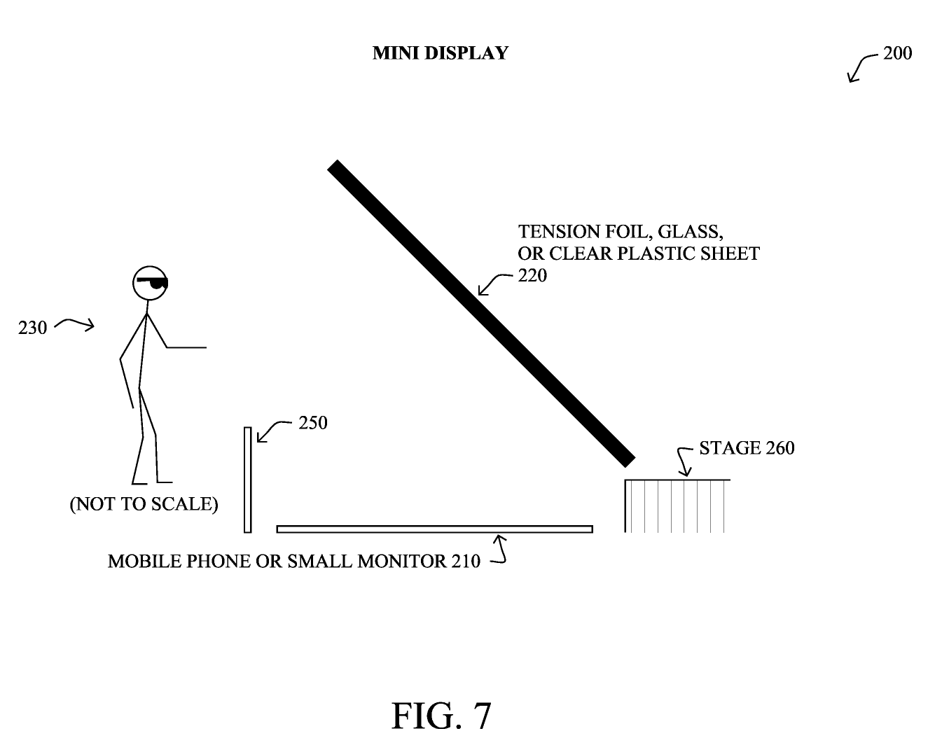

Example embodiments of different system arrangements are shown in FIGS. 4-7, such as large display setups shown in FIGS. 4-5 and small (“mini”) displays in FIGS. 6-7. (Note that the diffusion layer is omitted for clarity, but it may or may not be present for a particular setup as desired.) For instance, in FIG. 4, the video panel display 210 is located on the floor of the system (illustratively hidden from the viewer by a small wall 250 or other object), where the transparent screen 220 angles away from a stage 260, and over the panel(s) 210. FIG. 5, on the other hand, shows the large video panel display 210 above the transparent screen 220, and angled over the stage 260. Similar differences are shown for small or “mini” displays in FIGS. 6 and 7, where the stage, generally, could in fact be a table top or other small surface.

Notably, by displaying an image of an object or person with a black background on the light source, it is reflected onto the transparent flat surface so it looks like the object or person is floating or standing on its own. In accordance with typical Pepper's Ghost Illusion techniques, a stage or background can be put behind and/or in front of the transparent film so it looks like the object or person is standing on the stage, and other objects or even people can also be on either side of the transparent film. A major constraint in setting up a Pepper's Ghost display, however, is the large space requirement. In order to display a realistic holographic projection, a large amount of depth is typically needed behind the transparent screen.

In other words, the appearance of depth behind the transparent screen is very important to the overall holographic projection effect. In certain embodiments, therefore, to alleviate the large space requirement in setting up a Pepper's Ghost display (that is, since to display a realistic holographic projection, a large amount of depth is typically needed behind the transparent screen), an optical illusion background 270 may be placed behind the transparent screen in order to create the illusion of depth behind the screen (producing a depth perception or “perspective” that gives a greater appearance of depth or distance behind a holographic projection).

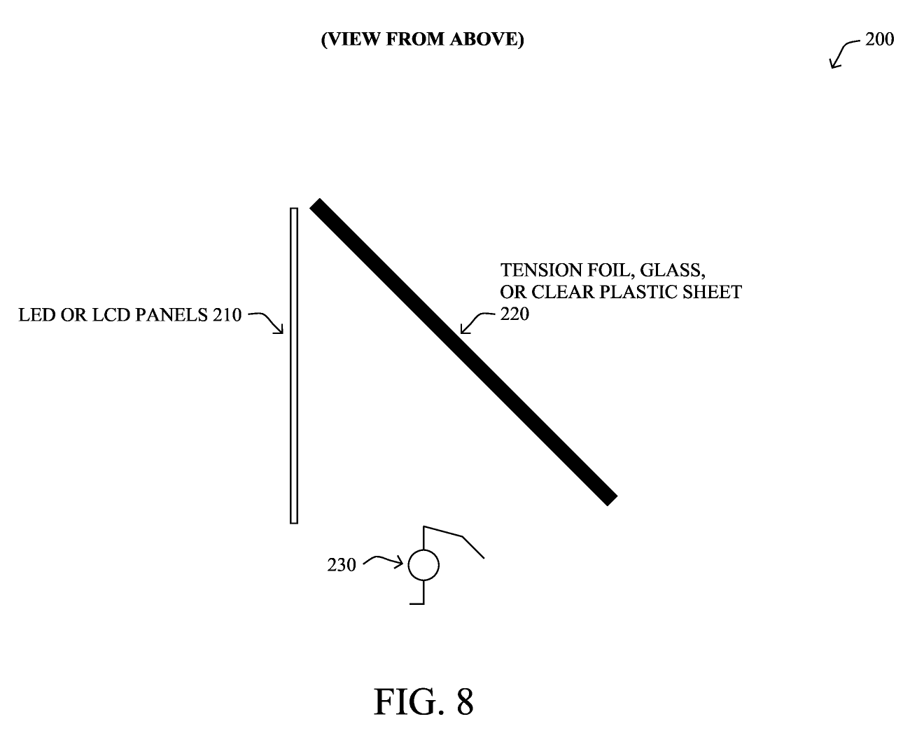

Note that in still another alternative embodiment, rather than placing the image source on the floor or ceiling, it is possible to place it on the side or wall, such as illustrated in FIG. 8. In particular, an LED/LCD panel 210 is shown on the side, with a transparent holographic screen 220 vertically placed in the middle at a 45-degree angle to the light panel (image source/video panel display).

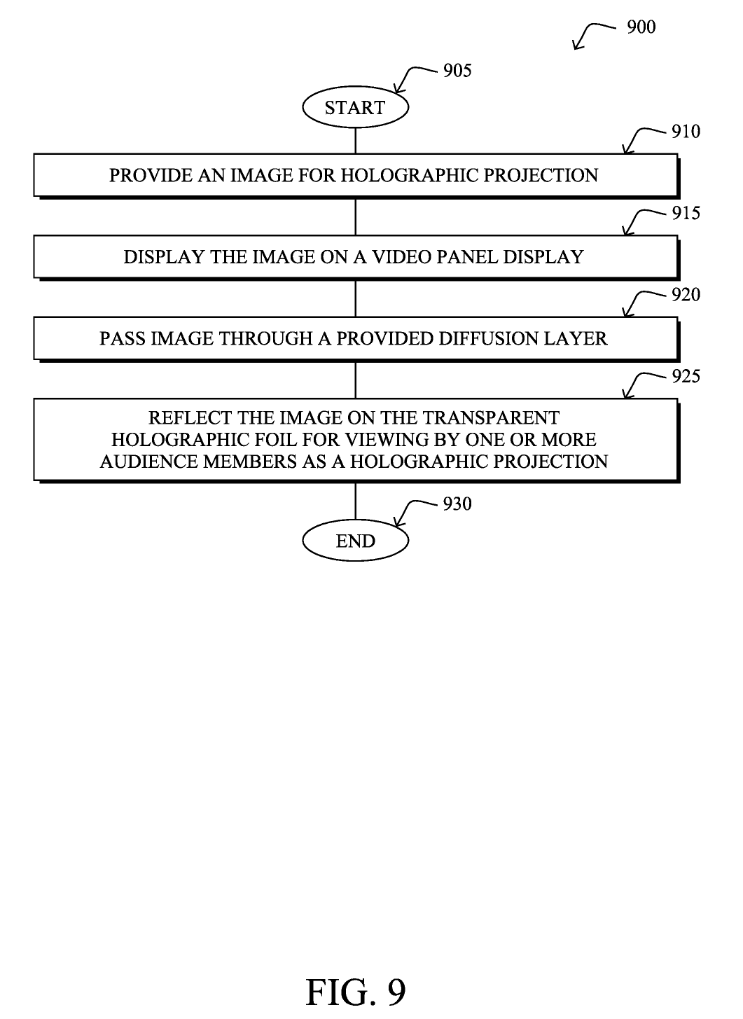

FIG. 9 illustrates an example simplified procedure for using video panel displays for an enhanced Pepper's Ghost Illusion in accordance with one or more embodiments described herein. The simplified procedure 900 may start at step 905, and continues to step 910, where an image is provided for holographic projection. In step 915, the image may be displayed on the video panel display, through a provided diffusion layer in step 920, and is then reflected in step 925 on the transparent holographic foil for viewing by one or more audience members as a holographic projection. The simplified procedure ends in step 930.

It should be noted that while certain steps within procedure 900 may be optional as described above, the steps shown in FIG. 9 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

Advantageously, the techniques herein provide for holographic projection techniques that allow for reduced system size, greater system versatility, and greater user experience. In particular, using video panel displays reduces the required set-up area, and also prevents problems associated with atmosphere effects (e.g., fog). In addition, the diffusion layer also helps mitigate the Moiré effect caused by video panel displays being reflected on the transparent screen/foil.

The embodiments described herein provide for holographic projection using video panels and also enhanced Pepper's Ghost Illusion techniques (e.g., added depth perception). Notably, the embodiments described herein may be used with holographic projection images produced from a variety of sources, such as live-streamed, pre-recorded, re-constructed, computer-generated, and so on. For example, as described in commonly owned, co-pending U.S. patent application Ser. No. 14/285,905, entitled “Depth Key Compositing for Video and Holographic Projection” filed on May 23, 2014 by Crowder et al. (the contents of which incorporated by reference herein in its entirety), special depth-based camera arrangements may be used to isolate objects from captured visual images, which may then be used to generate a visual display that shows only those isolated objects as a holographic projection. Other techniques may be used to create holographic projection images, however, and the technique mentioned above is merely one example.

Also, as another example, in computing, an “avatar” is the graphical representation of the user (or the user's alter ego or other character). Avatars may generally take either a two-dimensional (2D) form or three-dimensional (3D) form, and typically have been used as animated characters in computer games or other virtual worlds (e.g., in addition to merely static images representing a user in an Internet forum). To control an avatar or other computer-animated model (where, notably, the term “avatar” is used herein to represent humanoid and non-humanoid computer-animated objects that may be controlled by a user), a user input system converts user action into avatar movement. The systems described herein, therefore, may also be configured to display a holographic projection of an animated avatar, e.g., allowing an individual to interactively control a holographic projection of a character.

Moreover, while there have been shown and described illustrative embodiments, it is to be understood that various other adaptations and modifications may be made within the spirit and scope of the embodiments herein. For example, while the embodiments have been described in terms of video panels, still pictures (stationary images) may also benefit from the techniques herein, and any reference to “video” or “image” or “picture” need not limit the embodiments to whether they are motion or time-sequence photography or still images, etc.

Note also that any two-dimensional holographic imagery techniques may be used herein, and the illustrations provided above are merely example embodiments. Three-dimensional holographic images may also be used, but require multiple camera angles, multiple respective depth ranges, and greater data processing.

Further, the embodiments herein may generally be performed in connection with one or more computing devices (e.g., personal computers, laptops, servers, specifically configured computers, cloud-based computing devices, cameras, etc.), which may be interconnected via various local and/or network connections. Various actions described herein may be related specifically to one or more of the devices, though any reference to particular type of device herein is not meant to limit the scope of the embodiments herein.

The foregoing description has been directed to specific embodiments. It will be apparent, however, that other variations and modifications may be made to the described embodiments, with the attainment of some or all of their advantages. For instance, it is expressly contemplated that certain components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. An apparatus, comprising:
a panel display configured to provide a light source image for a holographic projection; and
a reflective transparent screen disposed angularly to the panel display;
wherein the light source image, when provided by the panel display, is reflected off the screen toward a viewing direction, the reflected light source image appearing from a perspective of the viewing direction as the holographic projection behind the screen.

2. The apparatus as in claim 1, further comprising:
a diffusion layer disposed between the panel display and reflective transparent screen, the diffusion layer configured to reduce a Moiré effect of the holographic projection.

3. The apparatus as in claim 2, wherein the diffusion layer is adjacent to the panel display.

4. The apparatus as in claim 1, wherein the panel display is selected from a group consisting of: a plasma display; a liquid crystal display (LCD); and a light-emitting diode (LED) display.

5. The apparatus as in claim 1, wherein the panel display is a personal electronic device.

6. The apparatus as in claim 5, wherein the personal electronic device is selected from a group consisting of; a watch; a mobile phone, a tablet, a laptop, a monitor, and a television.

7. The apparatus as in claim 1, wherein the screen is a tensioned foil.

8. The apparatus as in claim 1, wherein the screen is a rigid material.

9. The apparatus as in claim 8, wherein the rigid material is selected from a group consisting of: glass; plastic; and plexiglass.

10. The apparatus as in claim 1, further comprising:
an optical illusion background located behind the screen and configured to create an illusion of depth behind the screen.

11. A method, comprising:
providing a light source image from a panel display for a holographic projection; and
arranging a reflective transparent screen angularly to the panel display;
wherein the light source image, when provided by the panel display, is reflected off the screen toward a viewing direction, the reflected light source image appearing from a perspective of the viewing direction as the holographic projection behind the screen.

12. The method as in claim 11, further comprising:
providing a diffusion layer between the panel display and reflective transparent screen, the diffusion layer configured to reduce a Moiré effect of the holographic projection.

13. The method as in claim 12, wherein the diffusion layer is adjacent to the panel display.

14. The method as in claim 11, wherein the panel display is selected from a group consisting of: a plasma display; a liquid crystal display (LCD); and a light-emitting diode (LED) display.

15. The method as in claim 11, wherein the panel display is a personal electronic device.

16. The method as in claim 15, wherein the personal electronic device is selected from a group consisting of; a watch; a mobile phone, a tablet, a laptop, a monitor, and a television.

17. The method as in claim 11, wherein the screen is a tensioned foil.

18. The method as in claim 11, wherein the screen is a rigid material.

19. The method as in claim 18, wherein the rigid material is selected from a group consisting of: glass; plastic; and plexiglass.

20. The method as in claim 11, further comprising:
providing an optical illusion background located behind the screen and configured to create an illusion of depth behind the screen.
